(19) United States
(12) Patent Application Publication
(10) Pub. No.: US 2015/0134738 A1
(43) Pub. Date: May 14, 2015

(54) METHOD AND SYSTEM FOR VIEWING MULTIPLE PHYSICAL LOCATIONS CUSTOMER WAIT TIMES AT ONE INSTANCE FROM A PORTABLE ELECTRONIC APPLICATION VIA A COMMUNICATIONS NETWORK

(71) Applicants: Hans Emihle Mayo, Brooklyn, NY (US); Dwayne Isaac Williams, Brooklyn, NY (US)

(72) Inventors: Hans Emihle Mayo, Brooklyn, NY (US); Dwayne Isaac Williams, Brooklyn, NY (US)

(21) Appl. No.: 14/079,430

(22) Filed: Nov. 13, 2013

(51) Int. Cl. H04L 29/08

(52) U.S. Cl. CPC H04L 67/00
USPC 709/204

(57) ABSTRACT

This is directed to a methods and system for integrating waiting list and appointment check in services in a single application available on a portable electronic device for the purpose of local patrons being able to view multiple wait times of physical locations. Using the single application, a user can create waiting list (lines) and control their management without the need for a separate non-portable computer controlling the device's information and transmitting it back to a portable electronic device. This allows information to be controlled from the portable electronic device directly and with other PED's and no central computer controllers or web portal needed. The services solved by this method and system can include, creating waiting list (lines), deleting waiting list (lines), shifting waiters, deleting waiters, changing wait times, and adjusting distance a person must be before they can be added to a line. This method also allows the user and waiting list creator to adjust the data real-time from a portable electronic device as their circumstances change.

Note: This patent is not for reservation based systems, and does not include reservations or queuing through terminals, kiosk, desktop based application control, or web portals. This patent is for a waiting list management application where all functions are controlled from a portable electronic device for the benefit of information gathering users who need more than one waiting list data when decision making.

### TECHNICAL FIELD

The present invention relates to a portable electronic device method and system for managing waiting list (lines) and, more particularly to a method and system for controlling real-time variables that affect waiters without the need for human interaction.

### BACKGROUND OF THE INVENTION

In many parts of our lives mobile applications have increased our efficiencies in life and business. One key problem though has continued to plague everyday people is the issue of wasting time waiting due to lack of information, negligence and environmental factors. A key reason for the deficiency is the lack of an appropriate way to measure how long we will be waiting and communicate it efficiently to people waiting.

Many current solutions are hardware intensive which is very costly and more of a nuisance because it doesn't allow you to know how long you will be waiting. It just simply notifies you with an irate buzzing or beeping. Then there are other solutions that make use of text messaging which is inefficient because you're still trapped by not knowing how long you have to wait, how much time you have to return, and how many people are ahead of you as they update their information.

Other solutions are based on reservations, which can only be changed after knowledge of change is realized by information obtained by humans thus inefficient for real-time analytics. Also there are many waiting systems that are based on controlling queues through kiosk, desktop applications, and monitors in waiting areas with a mixture of all the pre-made solutions. This too is a waste figuring it relies on the need for personal contact to be made to initiate the interaction though you could continue your interaction through a mobile device. This just complicates matters.

Therefore, a need for a mobile application that simplifies and streamlines the process of getting into a line was needed. This patent is for that application that will have the knowledge of wait times and numbers in line. That single application also gives options of how to spend the estimated wait time. Which allows one to create a waiting list (line) from their portable electronic device and most importantly allows for technical and non-technical users the ability to manage the complicated process of waiting list management that has mostly up to this point been done by waiting list creating humans on customers input. This invention has now made it a group responsibility for the benefit of better real-time analytics.

No longer must a human be physically present to manage a waiting list, a text message need to be sent, a phone call made, loose time waiting for a line holder to be physically absent to update, or informed late that a waiter has left the line. Instead all these things will be completed and available in real-time on a portable electronic device without the need for anything other than your portable electronic device (PED). These data variables given by users and waiting list creators are necessary for new wait time users to make a decision based on time.

### SUMMARY OF THE INVENTION

One aspect of the invention is to provide a mobile application platform that accomplishes many burdensome tasks in one single application so two systems are not needed. The method and system purpose is to eliminate the need for physically waiting around for waiting list development and real-time maintenance. The application's purpose is to allow users to manage, create, and monitor real-time waiting list through a single application for the purpose of providing multiple wait times for decisions of which waiting list to join. This method is not a web portal and app system as some have tried to create, or a kiosk and phone text messaging system, or a reservation based system like used at theme parks. This method and system is a standalone system that can be used from your portable electronic device to control and access real-time data about your wait that changes as input changes with no delays.

Another aspect of this invention is the ability for a user to manipulated data that has variables not generally available for viewing on any solution currently created. A user with this invention has the ability to change and see more data than has previously been available to waiting users on a portable electronic device. Both the line creator (user) and multiple authorized users can view many variables such as, number of people in line, estimated wait, max wait, a countdown of time to be back to business in, current location of line, line name, business name, and all other means to identify, manipulate, monitor, and manage waiting list (lines) on a portable electronic device.

Another aspect of this invention is the ability for users to locate lines near their current location and view real-time wait time and number in line and line up at the location of their choice. The user now has the ability to select the restaurant, business, or lines that fits their personal/group time constraints. This application allows users to avoid going in multiple establishments only to find a long lines or wait-time.

### EXAMPLE

Two separate groups of friends go out to dinner in a downtown area. Upon arrival the two separate groups goes in various restaurants only find that there is a long wait to get seated. Before now they would have found this procedure exhaustive and chosen the closest alternative. With the invented method viewable in our claims listed in this patent they can see the various restaurants or other service providers wait times at one instance and make a selection on what restaurant or business to get in line. Now with this invention the first group sees all the wait times of the businesses nearby and chooses a location with the shortest wait. Once the first group gets into the restaurant line the wait times of physical locations are updated. The second group of friends does the search on our invention and they chose a different restaurant because now after the real-time update of the data with the first groups choice the wait will not be shorter at the same restaurant because of new waiters (first group of friends) and therefore they choose another option listed in the results.

What is claimed is:

1. A method and system comprising: collecting information from a user and waiting list creator for the purpose of providing multiple waiting times that other portable electronic device users can see and join if they desire the services provided and are willing to wait. This system provides a way for users to adjust details of the waiting list and through the application provide information of the status of their list or lines and alert joining users of the status of their wait.

2. The method of claim 1, for reviewing multiple real-time waiting lists (lines) data at one instance on a portable electronic device.

3. The method in claim 1, where the ability to see multiple real-time waiting list provides the user with the ability to choose a waiting lists (lines) to join by viewing the real-time data (i.e., waiting times) displayed on the portable electronic device.

4. The method of claim 1, wherein collecting information from a user and waiting list creator for the purpose of providing multiple waiting times that other portable electronic device users can manipulate the data variables from their own portable electronic device and not just a waiting list creator through text, phone call, kiosk, desktop based systems, web portal or any other non-portable electronic application only means.

5. The method of claim 1, wherein establishing a waiting list (line) that other application users can see on their portable electronic device for the purposes of monitoring their waiting status. Which in tandem with other lines created will provide multiple waiting lists to be seen at one instance from a portable electronic device.

6. The method of claim 1, where the system provides a way for the waiting list creators and users to adjust data variables in real-time of the waiting list and through application inform users of the said changes.

7. The method of claim 1, to display data variable such as wait times, and number in line, by line type, time, line count, distance or address for the purposes of viewing multiple wait times from a portable electronic device.
Note: This differs from reservations as the user is joining a real-time waiting list and not checking in to time slots or requesting a pre-reserved space. This also differs from other queuing methods that use computers to control the virtual queuing and not the users themselves. Another reason this differs from pre-existing queuing systems are that pre-existing queues are controlled by a master computer and information is then sent to outside devices and not wholly contained on portable electronic devices such as the ability to create a waiting list from a portable electronic device. This invention also differs from some solutions as the focus is not on your line but multiple lines. This is for the purpose of selecting places to visit based on wait times, not just see your current wait.
